(19) United States
(12) Patent Application Publication
(10) Pub. No.: US 2004/0165266 A1
(43) Pub. Date: Aug. 26, 2004

(54) Broadband polarization transformation devices

(75) Inventors: Tigran Galstian, Ste-Foy (CA); Dany Dumont, Quebec (CA); Armen Zohrabyan, Ste-Foy (CA); Amir Tork, Cap Rouge (CA); Rouslan Birabassov, Quebec (CA)

Correspondence Address: Mr. S. Peter Ludwig, DARBY & DARBY P.C., 805 Third Avenue, New York, NY, 10022, US

(73) Assignee: PHOTINTECH INC.

(21) Appl. No.: 10/370,870

(22) Filed: Feb. 20, 2003

(51) Int. Cl. G02B 5/30; G02B 27/28

(52) U.S. Cl. 359/484; 359/496

(57) ABSTRACT

Broadband polarization transformation devices of various constructions are provided. The devices of the invention include a plurality of polarization switching elements that are either wavelength insensitive or used only in a wavelength insensitive manner. Preferably, 90° or 45° twisted liquid crystal cells which are electrically switchable and achromatic birefringent elements (such as Fresnel Rhombs) are used. In a particularly advantageous embodiment, the device is composed of, consecutively, a 90°TLC cell, a 45°TLC cell, a Fresnel Rhomb and an additionnal 45° TLC cell, allowing an initially linearly polarized light beam to be switched between the output polarization states p, s, σ, −σ, 45° and −45° depending on the application of voltages on the TLC cells.

### FIELD OF THE INVENTION

The present invention relates to the field of polarization sensitive optical devices and more particularly concerns devices allowing the wavelength-independent transformation of the polarization of broadband light beams.

### BACKGROUND OF THE INVENTION

Optical information transmission and processing systems include guided wave and integrated optical components, which are often polarization sensitive. This is the case even for components which are built from isotropic, that is polarization insensitive, materials. Such dependence may create significant problems for light processing operations. For example, if the optical signal has two different polarization components, then their propagation conditions may be different. It may result in polarization dependent cross-talk, polarization mode dispersion (PMD) and polarization dependant losses (PDL). For this reason, polarization controlling and transformation elements have been developed to compensate for the polarization dependence of optical devices and networks. However, this dependence must be dynamically monitored since there exist different mechanisms of polarization changes in the optical network and they may change in time. In this respect, one of the most important problems to anticipate will be the PMD. This arises from the increasing needs in optical-communication systems, which forces an increase of the bit rate in time division multiplexing (TDM) systems, using shorter optical pulses as information bits. If the polarization dependence of the system is not well mastered, the temporal broadening of these pulses due to the PMD may then increase the error level in transmission systems.

Another type of encoding schemes for optical telecommunications, which is considered in parallel with TDM, is the combination of more information carrying wavelengths in the same transmission line, in so-called wavelength division multiplexing (WDM) systems. The corresponding spectral domain, which is presently used for information transfer and monitoring, ranges from 1200 nm up to 1600 nm and may be further broadened. In this field, if the service providers wish to test the polarization performance of communication circuits, they have to use polarization transformers, which should preferably be wavelength independent. Presently known monitoring devices use rotating phase plates to generate various polarization states and to test the optical transmission devices and systems. However, because of the wavelength dependence of these plates, the monitoring of these systems is done separately for each wavelength. Such characterization may thus take several hours of work. The availability of wavelength independent polarization transformers, which conserve the light intensity, could allow the simultaneous testing of polarization properties of all WDM channels and could thus reduce the total testing time up to seconds.

Various approaches may be used (e.g., Muller and Stokes parameters or the sphere of Poincare) to describe the polarization state (PS) of light. Referring to FIG. 1 (PRIOR ART), there is for example shown (by open circles) the main 6 PSs of light propagating along the z axis. The PSs corresponding to the positions of the points 1&3 on the Poincare sphere are linear polarizations along x&y axes, respectively, while the positions 2&4 represent linear polarizations tilted at ±45° (between x&y axes) and finally the points 5&6 represent opposed (right and left) circularly polarized states. The gradual change of the PS, at fixed light intensity, corresponds to a movement of the representing point on the same Poincare sphere. Devices allowing such changes should preferably exclude mechanically moving parts. This need explains in part the efforts, which were made to develop electrically controlled polarization transformation devices.

Very often, only a few key polarization states are required to test the polarization dependence of a device. Consequently, the development of a component, which could generate these states without wavelength sensitivity would be appreciated. As mentioned above, the traditional way of changing the PS of light is the use of rotating passive half wave and quarter wave plates. However, these elements are designed for certain wavelengths only and their use for relatively wide spectral bandwidth (e.g. 100-400 nm) will result in various PSs for different wavelengths (and therefore for different communication channels). Also, they require mechanical rotation to change the PS of light, which is always undesirable in optical systems. The problem of wavelength sensitivity remains as a severe limitation event if electro-optic modulation elements without moving parts are used, because of the intrinsic dispersion of the material.

Today's most widely used electro-optic technology is based on liquid crystal (LC) materials, which unfortunately, are also wavelength selective. The optical axis of a LC is usually described by a unit vector n, commonly called the director, which shows the local average orientation of molecular axes. The 3D picture of a basic element of a LC device is schematically presented in FIG. 2a (PRIOR ART). The electro-optic cell is composed of an entrance surface 1 with an orientation 2 of the director of the LC on that surface. There is also an exit surface 3 with, in general, another direction 4 of the LC's director. In the present case, these directions are parallel, so the orientation of the director n is uniform in the volume of the cell. Usually, there are also transparent electrodes on the surfaces 1 and 3. These electrodes allow the application of an electric field E, as seen in FIG. 2B (PRIOR ART), which results in the reorientation of the local optical axis of LC (which is parallel to n) in the volume of the cell. This reorientation is shown by the arrow 6, which is getting out from the intermediate surface 5 (lying in the x,y plane) and tends to be parallel with the electric field E (for a LC with positive dielectric anisotropy, Δε>0). In this case, two polarization components Eₑ and Eₒ of an incident light will propagate in the LC with different propagation constants (kₑ≠kₒ) and will accumulate a relative phase shift at the exit surface 3 of the cell. This will create the desired change in the PS of light.

Many applications have been developed using initially homogeneous or uniform cells as described above. Referring to U.S. Pat. No. 5,740,288 (PAN) there is shown the use of one or two such uniform LC cells to control the polarization of the incoming light by orientation of the optical axes of one or two LC cells placed between two or more fibers and beam splitter cube cells. By such a control, light from two input fibers can be sent to the output fiber in any desired ratio. The device is used as a variable polarization beam splitter, combiner or mixer.

A more complex change of the PS of light is achieved in U.S. Pat. No. 5,005,952 (CLARK et al), through the use of three consecutive homogeneous LC cells. Such an arrangement is shown herein in FIG. 2C (PRIOR ART). CLARK teaches the use of such stacked cells to generate a controlled phase retardation between the optical axes of the cell, thereby switching the polarization of the input light beam from a linear to an elliptical state. However, as the slow and fast axes will experience different propagation constants, the resulting polarization change will be wavelength dependent.

The accumulated phase difference, used in almost all previous realizations depends, in general, upon the incident light's wavelength λ, in part due to the material dispersion of the LC, that is, the wavelength dependence of its optical birefringence Δn(λ). This fact will introduce undesired wavelength sensitivity, excluding such applications, as for example, the simultaneous performance monitoring for many communication channels or the extension to broadband signals of the dynamic 1 to 2 ports switches as described in U.S. Pat. No. 5,740,288.

The wavelength sensitivity issue was particularly addressed in U.S. Pat. No. 6,144,433 (TILLIN et al.), where the LC layer was arranged for operation in surface switching mode, thus creating various regions of the LC layer adjacent to the alignment layers being mutually optically de-coupled. This improvement was done still in the same intensity modulation context (using polarizers to cut light intensity) and did not allow the creation of the key set of polarization states of light, for example, the circular PS.

All of the above-described devices use uniform LC cells where the direction of the director n is uniform through the volume of the cell. Also known in the art are so-called 90° twisted LC (90°TLC). The basic elements of a 90°TLC cell are presented in FIG. 3A (PRIOR ART). The electro-optic cell is composed of an entrance surface 1 with an orientation 2 of the director of the LC and an exit surface 3 with a 90° rotation (direction 4) of the LC's director. In the absence of any electric field (E=0), the director 6 of the LC in any intermediate surface 5 is in the (x,y) plane and exhibits a continuous rotation from the first to the exit surfaces. In this case, each polarization component (e.g., Eₑ) may be “polarization guided”, which consists in the adiabatic following of the director n by this polarization [P. G. De Gennes]. Such polarization-guiding regime is possible in twisted birefringence media when the local optical birefringence Δn is high enough and the period of the twist P is relatively large. The condition for being “guided” is the product of those values, which must be compared to the wavelength λ of the guided light. This condition may be easily satisfied for a broadband telecommunication light (λ=1.4±0.2 μm) in typical LC cells with Δn≧0.2 and P≧20 μm. Note that if both polarization components (Eₑ,Eₒ) are present in the incident light, then they will be simultaneously “polarization guided” with however different propagation constants (kₑ≠kₒ) and will accumulate a relative phase shift at the exit 3 of the cell. This again will create a wavelength dependent polarization change, because of the same material dispersion (Δn(λ)) and the total phase shift that is proportional to 2πΔn/λ.

The above-defined 90°TLC cell is also provided with transparent electrodes on the surfaces 1 and 3 (see FIG. 3A). The application of an electric field E results in the reorientation of the optical axis in the volume of the cell. The LC director then gets out (not shown in the figure) from the intermediate surface 5 and tends to be parallel with the electric field E (for a positive dielectric anisotropy, Δε>0). In the case of a sufficiently strong field E, the director of the LC is parallel with E almost through the whole volume of the LC. In this case, there is no rotation of polarizations and the electric field components of light (Eₑ,Eₒ) propagate with the same propagation constant (kₑ=kₒ).

Known in the art are display (intensity modulation) devices based on 90°TLC cells. They generally also contain an input polarizer 7 (say, with a transmission axis along x of FIG. 3A) and an output polarizer 8, which may have a transmission axis parallel with x (initial extinction mode) or y (initial transmission mode) axes. Thus, one can obtain electric field E induced switches between transmission and opaque regimes, the input light having only the polarization component Eₑ, which is rotated at 90° in the absence of electric field or transmitted without rotation in the presence of the electric field. TLC cells with a total twist angle of the director n different then 90° are also known. For example, FIG. 3B shows a TLC cell having a 45 twist angle. Cells having a twist angle more than 90° may also be built, usually applying surface pretilt angles and/or chiral additives, as for example so called “super twisted” LC cells having a 270° twist angle.

The performance of such devices has been improved over many decades to get quicker switches, higher extinction ratio and larger view angles. Also well known in the art is the provision of alignment pretilt angles, usually applied to avoid the domain formation or to accelerate the switching time. For example, U.S. Pat. No. 4,566,758 (BOS) shows such cells fabricated so that the directors of the input and output surfaces are tilt-biased in opposite directions. In the BOS patent and other known prior art references, such devices are always used to create an accumulative retardation of light for a predetermined wavelength. The same issue of the switching time was improved in U.S. Pat. No. 6,094,246 (WONG et al), using partially twisted liquid crystal (TLC) cells. The operation of the described devices is strongly wavelength sensitive and targets the switching intensity extinction value. The application of two crossed polarizers in this patent allowed the improvement of that ratio up to −25 dB. In fact, in all these applications, at least one exit polarizer has been used to modulate the output light intensity, since variable light attenuation was always required. In all cases, the transformation of the polarization state of light, using the described above devices, remains either wavelength sensitive or is missing some key polarization states (e.g., the achromatic switch to circular polarizations). The only known wavelength insensitive circular polarizers were made from combinations of fixed optical retarders (half wave and quarter wave plates) with different azimuthal orientations of their optic axes.

There is therefore a need for a device allowing the creation of non-mechanical switches between various key polarizations states, preferably including circular PSs, with significantly less wavelength sensitivity than for prior art devices.

### OBJECTS AND SUMMARY OF THE INVENTION

It is an object of the present invention to provide a polarization transformation apparatus allowing a switch between various polarization states of a broadband light signal.

It is a preferable object of the present invention to allow the achromatic creation of 6 extreme polarization states of light.

It is another preferable object of the present invention to allow such a polarization transformation without any mechanical movement or significant changes of light's intensity, thus staying on the same Poincare sphere.

According to a first aspect of the present invention, there is provided a broadband polarization transformation apparatus for switching a polarization state of a light beam from a linear initial polarization state to one of a plurality of output polarization states, irrespectively of the spectral distribution of the light beam.

The apparatus includes a switchable first polarization changing element having an input plane and two perpendicular polarization specific axes lying therein. The light beam is impinged normally on the input plane with its initial polarization state aligned with one of the polarization specific axes. First switching means are provided for switching the first polarization changing element between a first mode outputting the light beam with its polarization rotated into alignment with the other one of the polarization specific axes, and a second mode outputting the light beam with its polarization unchanged.

A switchable second polarization changing element is also provided, having an input plane, two perpendicular polarization specific axes lying therein in alignment with the polarization specific axes of the first polarization changing element. The light beam outputted from the first polarization changing element impinges normally on the input plane of the second element. Second switching means allow switching of the second polarization changing element between a first mode outputting the light beam with its polarization rotated by a predetermined angle, and a second mode outputting the light beam with its polarization unchanged.

In accordance with a preferred embodiment of the invention, the first and second polarization changing elements are respectively 90° and 45° twisted liquid crystal cells, and the first and second switching means include pairs of electrodes disposed on the input and output faces of the corresponding cell. In this manner, the apparatus allows a rotation of the initial polarization state of the light beam by either 0°, 90°, 45° and −45° with respect to the input plane depending on the mode of each polarization switching element.

In accordance with another embodiment of the present invention, in addition to the components mentioned above the apparatus further includes a third polarization changing element, positioned to receive therethrough the light beam outputted from the second polarization changing element. The third polarization changing element has two perpendicular polarization specificaxes (or planes) and introduces a phase delay between polarization components of the light beam respectively aligned with these axes. Preferably, the polarization specific axes of the third polarization changing element are aligned with the polarization specific axes of the second polarization changing element, and the introduced phase delay is π/2. In this manner, the apparatus according to this embodiment can output the light beam with either the p, s, as well as circular σ or −σ polarization states depending of the operation modes of the first and second polarization switching elements. The third polarization changing element is preferably a rhomb of Fresnel. It may be also another achromatic waveplate, a zero-order waveplate, etc. depending upon the spectral band of optimal operation.

In accordance with yet another embodiment of the invention, the apparatus as described in the previous embodiment further includes a switchable fourth polarization changing element positioned to receive therethrough the light beam outputted from the third polarization changing element. The fourth polarization changing element has two perpendicular polarization specific axes, aligned with the polarization specific axes of the first, second and third polarization changing elements. Third switching means are provided for switching the fourth polarization changing element between a first mode outputting the light beam with its polarization rotated by a predetermined angle, and a second mode outputting the light beam with its polarization unchanged. Preferably, the fourth polarization switching element is a 45° twisted liquid crystal cell, and the third switching means are embodied by a pair of electrodes disposed on the input and output of this cell. In this embodiment, the apparatus according to this embodiment can output the light beam with either the p, s, 45°, −45°, σ or −σ polarization states depending of the operation modes of the first, second and fourth polarization switching elements.

In accordance with another aspect of the present invention, there is provided another broadband polarization transformation apparatus for switching a polarization state of a light beam from a linear initial polarization state to one of a plurality of output polarization states, irrespectively of the spectral distribution of this light beam. This apparatus includes a switchable first polarization changing element positioned to receive the light beam therethrough. The first polarization changing element has two perpendicular polarization specific axes, one of which being aligned with the initial polarization state of the beam. The apparatus also includes switching means for switching the first polarization element between a first mode outputting the light beam with its polarization rotated by a predetermined angle, and a second mode outputting the light beam with its polarization unchanged.

A second polarization changing element is further provided and positioned to receive therethrough the light beam outputted from the first polarization changing element. This second polarization changing element has two perpendicular axes, and introduces a phase delay between the polarization components of the light beam respectively aligned with the said axes of the second polarization changing element.

Preferably, the second polarization switching element is embodied by a Fresnel Rhomb introducing a phase delay of π/2 between the polarization components aligned with the specific axes. The first polarization changing element may for example be embodied by a 45° twisted liquid crystal cell, switchable through the application of an electric field between its input and output faces. With the second polarization changing element positioned to have one of its axes aligned with the polarization of the light beam outputted by the first polarization changing element in the first or second modes, the output polarization state of the light beam will be transformed to a circular state. The polarization of light will remain unchanged if the first polarization modulation element is then switched to the mode, which rotates the light polarization to 45° out of said axes (planes) of the second polarization transforming element. Alternatively, the first polarization changing element may be embodied by a 90° twisted liquid crystal cell, and the second polarization element oriented with its polarization specific axes making a 45° angle with one of output polarization directions of the first polarization changing element. In this manner, the output polarization state of the light beam may be switched between σ and −σ.

Advantageously, the positioning order and number of polarization changing elements may be modified depending upon the desired set of polarization states. Various liquid crystalline materials and orientational configurations may be applied to achieve the same goal as the aforementioned twisted liquid crystal cells. Broadband phase retardation components (preferably anisotropic and achromatic) are optionally used to improve the performance of the device.

Further advantages and features of the present invention will be better understood upon reading of preferred embodiments thereof with reference to the appended drawings.

### BRIEF DESCRIPTION OF THE DRAWINGS

FIG. 1 (PRIOR ART) is a 3-dimensionnal representation of a sphere of Poincare.

FIG. 2A (PRIOR ART) is a schematic representation of a uniform liquid crystal cell; FIG. 2B (PRIOR ART) is a schematic representation of such a liquid crystal cell illustrating director reorientation therein; and FIG. 2C (PRIOR ART) is a schematic representation of the combination of three such cells.

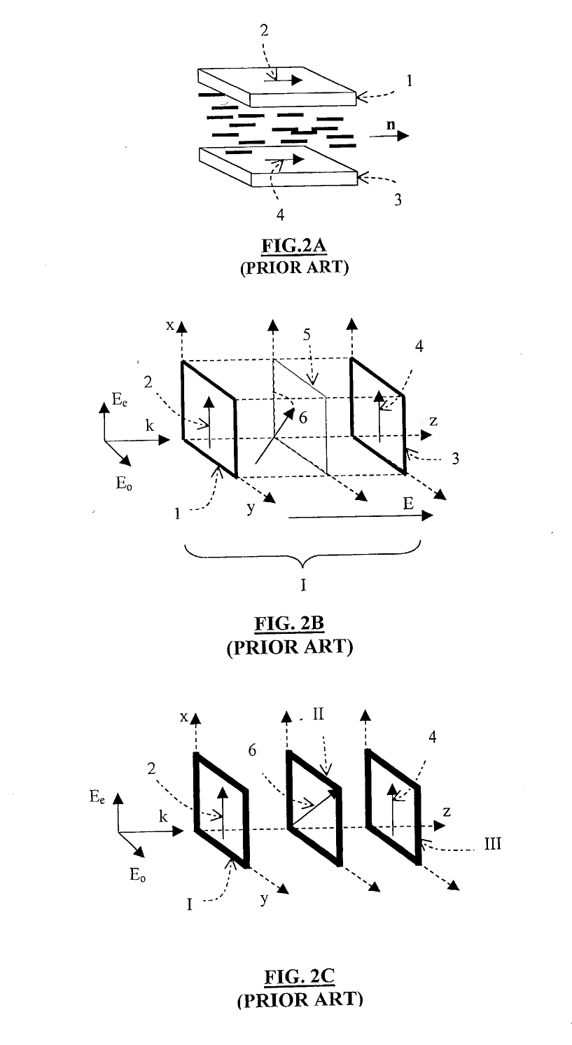

FIG. 3A (PRIOR ART) is a schematic representation of a 90° twisted liquid crystal cell; and FIG. 3B (PRIOR ART) is a schematic representation of a 45° twisted liquid crystal cell.

FIG. 4 is a schematic representation of a broadband polarization transformation apparatus including one 90° and one 45° twisted liquid crystal cells according to a first embodiment of the present invention.

FIG. 5A (PRIOR ART) is a side view of a Fresnel rhomb illustrating its effect on a light beam in the p state; FIG. 5B (PRIOR ART) illustrates the effect of a similar device on s polarized light; and FIG. 5C (PRIOR ART) illustrates the effect of a similar device on a light beam of linear polarization making a 45° angle with the polarization specific axes of the device.

FIG. 6A is a schematic representation of a broadband polarization transformation apparatus including a 45° twisted liquid crystal cell and a Fresnel Rhomb, according to another embodiment of the present invention; and FIG. 6B is a schematic representation of similar apparatus including a 90° twisted liquid crystal cell and a Fresnel Rhomb.

FIG. 7 is a schematic representation of an apparatus according to FIG. 4 with the addition of a Fresnel Rhomb

FIG. 8A is a schematic representation of an apparatus according to FIG. 7 with the addition of a further 45° twisted liquid crystal cell according to another embodiment of the present invention. FIG. 8B shows an algorithm of generation of various extreme polarization states using the apparatus of FIG. 8A.

FIG. 9 illustrates the use of the LC device in all-fiber and spectrally selective applications.

### DESCRIPTION OF PREFERRED EMBODIMENTS OF THE INVENTION

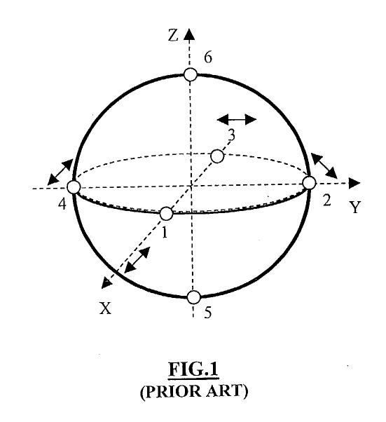

The present invention concerns the combination and judicious positioning of polarization changing elements for the purpose of the broadband polarization transformation of a linearly polarized light signal. The apparatus according to preferred embodiments of the invention are preferably electrically tunable and may be used, e.g., in optical communication systems to obtain the key set of 6 polarization states of light in achromatic manner. The illustrated embodiments of the invention advantageously allow this operation without any mechanical movements and using only low-voltage sources. The resulting change of the polarization state of light may be described by a movement of the polarization point on the same sphere of Poincare since the intensity of light is concerved (FIG. 1 (PRIOR ART)).

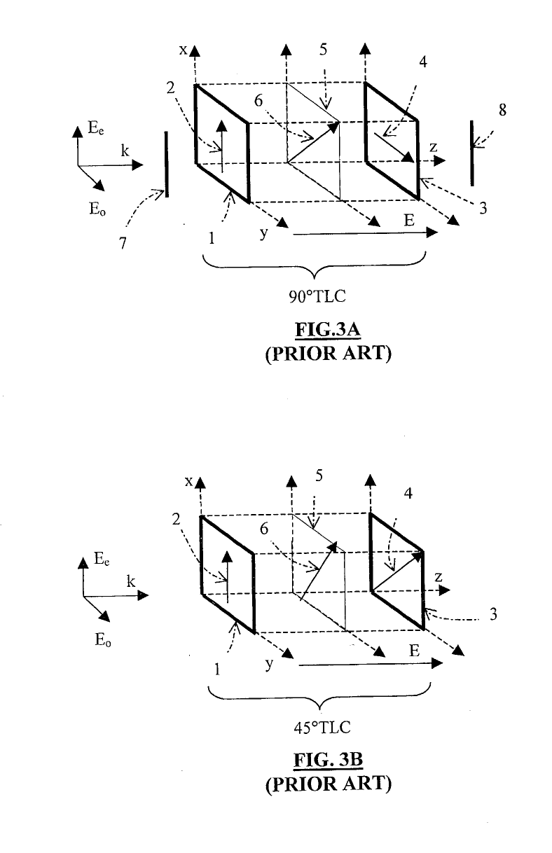

The polarization changing elements used in the present invention are preferably based on LC components having a twisted director configuration. The application of a twisted cell is known, in the prior art, to rotate the plane of the linearly polarized light. The transmission of this light through, e.g., the cell 45°TLC shown in FIG. 3B (PRIOR ART), in the passive mode, i.e. when no excitation is applied to the cell, will result in the rotation of the plane of polarization at 45°, according to the polarization guiding principle described earlier. FIG. 3A (PRIOR ART) shows a 90° TLC based on the same principles. We can define a specific description way to shorten our further analyses. The operation mode 0 will hereinafter be used to describe the case when there is no electric field or any other excitation applied on the cell substrates (V=0=E). In contrast, the case when a sufficiently strong (typically few volts) voltage is applied to the cell will be noted as mode 1. Resuming, we shall have polarization rotation for the mode 0 and no rotation for the mode 1.

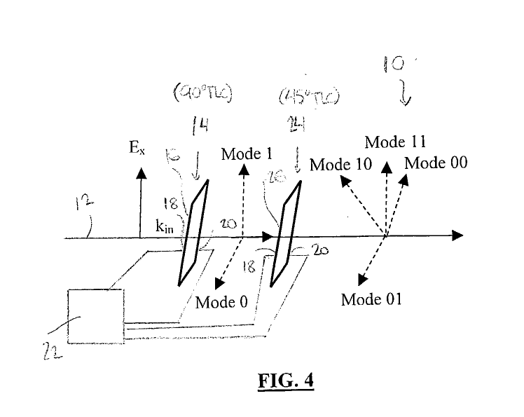

Referring to FIG. 4, there is shown a broadband polarization transformation apparatus 10 according to a first aspect of the present invention. The apparatus 10 receives at its input a light beam 12 propagating along the z-axes and having a linear initial polarization state represented by electric field component Eₓ. This polarization state will be switched to one of a plurality of output polarization states irrespectively of the spectral distribution of the light beam 12, as will be explained below. The input linear polarization may be created using a broadband polarized source, polarization controller or a polarizer, or any other appropriate device which is oriented along x or y axes, and this will not change the performance principles of the present invention.

The apparatus includes a switchable first polarization changing element, preferably embodied by an electro-optic device. In the illustrated example of FIG. 4, the first polarization changing element is embodied by a 90° twisted liquid crystal cell 14. It has an input plane 16 and two perpendicular polarization specific axes lying in this plane, here represented by axes x and y. The light beam 12 impinges normally on the input plane 16, therefore propagating along axis z in the illustration of FIG. 4, with its initial polarization state aligned with one of said polarization specific axes. In the present embodiment, the polarization of the light beam is aligned with the x axis, but it will be readily understood that it could alternatively be aligned with the y axis without affecting the working of the present invention. First switching means are provided for switching the first polarization element between a first mode (mode 0) outputting the light beam with its polarization rotated into alignment with the other one of said polarization specific axes, and a second, mode (mode 1) outputting the light beam with its polarization unchanged. In this case, the first switching means are preferably embodied by a pair of transparent electrodes 18 and 20 respectively mounted on the input and output surfaces of the 90°TLC cell 14 and generating an electric field therebetween. A power source 22 is connected to these electrodes 18 and 20 for this purpose.

Still referring to FIG. 4, the apparatus 10 further includes a switchable second polarization changing element also having an input plane 26 and two perpendicular polarization specific axes lying therein. In the illustrated embodiment, the second polarization changing element is embodied by a 45°TLC cell 24. The axes of the 45°TLC cell 24 are in alignment with the polarization specific axes of the preceding 90°TLC cell 14, and are therefore again represented here as axes x and y. The light beam outputted from the first polarization changing element impinging normally on the input plane 26. Similarly to before, second switching means such as another pair of electrodes 18 and 20 are provided for switching the second polarization changing element between a first mode outputting the light beam with its polarization rotated by a predetermined angle α, which is 45° for the case of a 45°TLC cell, and a second mode outputting the light beam with its polarization unchanged. The electrodes 18 and 20 of each switching means may all be powered by a single power source or alternatively by different (independent) ones according to any combination.

In summary, this first aspect of the present invention is preferably embodied by an apparatus composed of a 90°TLC cell and a 45°TLC cell, which are consecutively placed and mutually oriented in a way that the output polarization state of light from the 90°TLC cell makes in the mode 0 an angle of 0° or 90° depending upon the input polarization with respect to the orientation of the director n of the 45°TLC cell at its entrance plane. Imagine that the rotation directions of directors of both cells are right handed and that we have a p plane polarized (along the x axis) light, which is incident on the 90°TLC cell. For the simplest mode of no voltages on both cells, we shall obtain first a 90° rotation (mode 0) and then a 45° rotation (mode 00) of the polarization plane of light. In this case, light will emerge from the device with a polarization plane oriented at −45°. The application of the switching voltage only on the 90°TLC cell will eliminate the first rotation and the polarization plane of the incident light (mode 1) which will then be aligned at +45° with respect to the initial polarization after the 45°TLC cell (mode 10). In addition, this device can provide also two plane polarized (p and s) states, if respectively, electrical fields are applied on both cells (mode 11) and if a field is applied only on the 45°TLC cell (mode 01). We can thus obtain the following 4 extreme polarization states: p, s, +45°, −45° (see the sphere of Poincare, FIG. 1).

Advantageously, it will be understood that should for some reason an output angle other than ±45° is desired, the predetermined rotation angle α of the second polarization changing element 24 may be selected accordingly, and the output polarization states will be p, s, +α and −α.

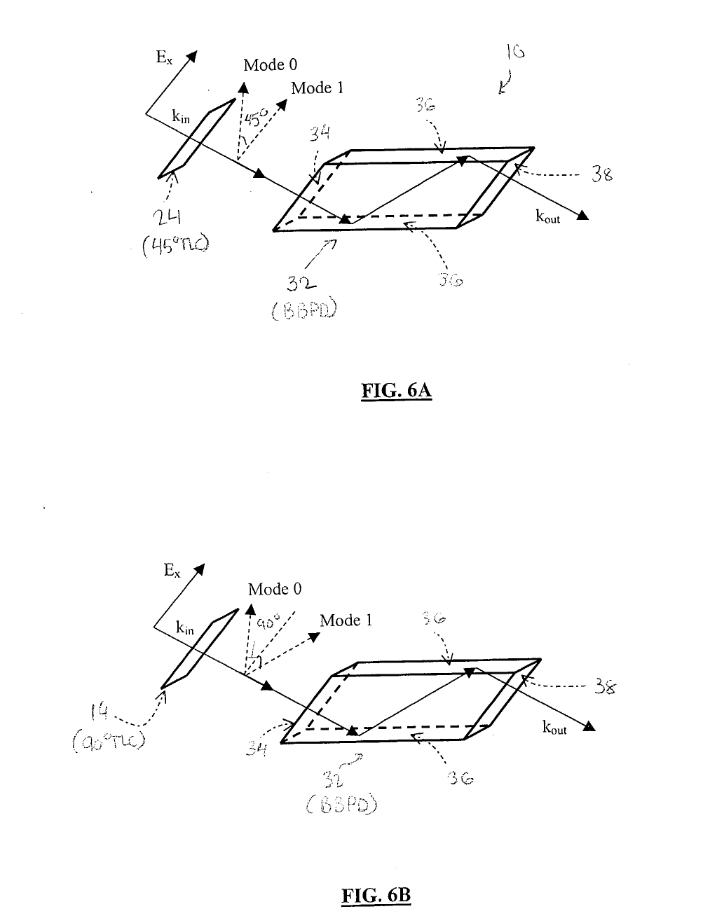

Referring to FIGS. 6A and 6B, there is shown an alternative embodiment of the present invention. The apparatus 10 according to the new embodiment includes a switchable first polarization changing element which may be embodied by either a 45°TLC 14 (FIG. 6A) or a 90°TLC 24 (FIG. 6B). Appropriate switching means are also provided. This time, a second polarization changing element, which is not switchable, is positioned to receive therethrough the light beam outputted from the first polarization changing element. The second polarization changing element has two perpendicular polarization specific axes and is a broadband phase delay component, which has the particularity of introducing a phase delay between polarization components of the light beam respectively aligned with these polarization specific axes. A Fresnel Rhomb 32 is a preferred device accomplishing this function, which is well known in the prior art.

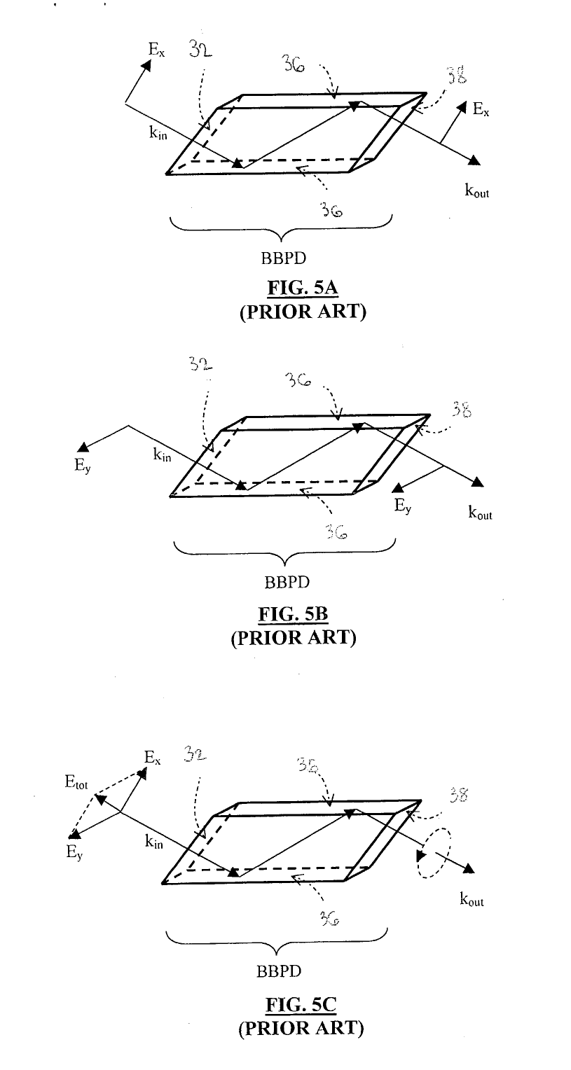

Referring to FIGS. 5A, 5B and 5C (PRIOR ART), there is shown an example of such a rhomb of Fresnel, which has an entrance surface 34, typically two reflective surfaces 36 and an exit surface 38. The input light with wave vector kᵢₙ undergoes consecutive reflections on the reflective surfaces 36 and is directed to the output of the rhomb 32 with wave vector kₒᵤₜ always remaining in the same (so-called “incidence”) plane, which is perpendicular to the surfaces 34 and 36. The device is designed in a way to introduce a differential phase delay between the two cross-polarized components Eₓ and E_{y}, which respectively represent the p (or TM) and s (or TE) polarizations for the entrance and exit surfaces 34 and 38. The absolute phase delay for each incident component separately (Eₓ or E_{y}) will not change its polarization state if they are pure polarizational TE or TM modes of the optical system (as respectively shown in FIG. 5A and FIG. 5B). However, the output polarization is circular (for example with a circularity sign σ) if both polarization components Eₓ and E_{y} are present at the entrance of the rhomb 32 and their initial phase difference is Δφᵢₙ=0±2πm, where m is integer, as shown in FIG. 5C. The output polarization circularity sign will be the opposite one (−σ) if the input polarization components Eₓ and E_{y} have an initial differential phase delay Δφᵢₙ=π±2πm. Unlike quartz waveplates, Fresnel rhombs are inherently less sensitive to wavelength (i.e. achromatic) since the output phase shift between TE and TM modes is a function of the glass index, which varies only slightly over the designed wavelength range (which may be between 400 nm and 2000 nm for BK7 glass). The term “BBPD” shall hereinafter be used to describe a broadband phase delay component, as the rhomb of Fresnel, while other static components or their combinations also may be used to obtain a similar performance.

Referring again to FIG. 6A, there is shown a particular embodiment of this aspect of the present invention where the apparatus 10 includes a 45°TLC cell 14 (for example with right handed rotation) and a BBPD 32, consecutively placed and mutually oriented in a way that the output polarization of light from the 45°TLC cell in the mode 0, that is when no field is applied on the 45°TLC cell, makes an angle +45° with respect to the incidence plane for the BBPD. This means that it generates both TE&TM polarization modes in the BBPD. In this case, the final polarization state of the output light from the BBPD 32 will be circular polarization (as in FIG. 5C). This transformation will be achromatic, that is, the same for many wavelengths, since both of the transformations used are broadband. The application of the switching voltage on the 45°TLC cell will eliminate the rotation of the initial polarization (mode 1), and the polarization plane of the incident light will then make 0° with respect to the incidence plane, thus generating only the p polarization component at its output (as in FIG. 5A). In this case, the final polarization state of the output light will be the same linear polarization as for the input light. Thus, we obtain an electrically controllable, broadband quarter wave device, which transforms the linear polarized light into a given circular polarization without using any mechanically moving parts. Note that here and afterwards the calculation base for the incident on the BBPD angle may be different for −45° or +45° definitions, which however will not change the operation principles of the present invention.

Referring now to FIG. 6B, there is illustrated an alternative to the above embodiment where the apparatus 10 includes a 90°TLC cell 24 followed by a BBPD 32, consecutively placed and mutually oriented in a way, that the output polarization of light from the 90°TLC cell 30 in the mode 0 (when no field is applied) makes and angle +45° with respect to the incidence plane for reflection interfaces 36 of the BBPD 32, such as schematically shown in FIG. 5B. Thus it generates both polarization modes in the BBPD, which are in the same phase Δφᵢₙ=0±2πm. In this case, the final polarization of the output light from the BBPD will be a circular polarization σ. This transformation also will be the same for many wavelengths since both components used are broadband. The application of the switching voltage on the 90°TLC cell will eliminate the rotation (mode 1). The polarization plane of the incident light will then make −45° with respect to the same incidence plane, still generating both polarization components, but in the opposed phase Δφᵢₙ=π±2πm. In this case, the final polarization state of the output light from the BBPD will be circular with a circularity sign −σ, which is opposed to the one in the mode 0 (without field). Thus, we obtain an electrically controllable broadband quarter wave device, which transforms the linear polarized light into a circular one and which, in addition, can invert the output circular polarization sign without using any mechanically moving parts.

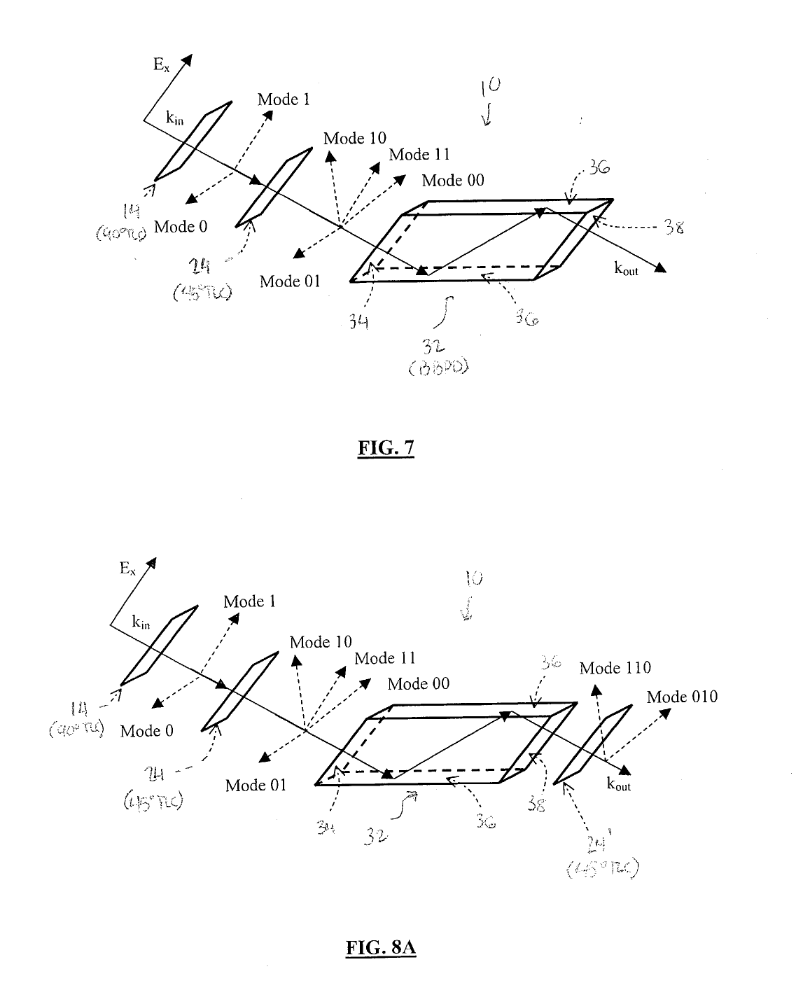

Referring to FIG. 7, there is shown another apparatus according to the present invention combining the characteristics of the devices discussed above. This apparatus 10 includes three polarization changing elements: the first is a 90°TLC cell 14, the second a 45°TLC cell 24 and the third a BBPD 32, consecutively placed and mutually oriented in a way, that the output polarization of light from the 90°TLC cell makes (in the mode 0) an angle 0° (or 90° depending upon the input polarization) with respect to the orientation of the director n of the 45°TLC cell at its entrance plane, which in turn is placed between the 90°TLC cell and BBPD and oriented in a way, that the output polarization of light from the 45°TLC cell makes an angle +45° (in the mode 0) with respect to the incidence plane of the BBPD. The described configuration may generate both (TE&TM) polarization modes in the BBPD, which may be in the same phase (Δφᵢₙ=0±2πm) or in the opposed phase (Δφᵢₙ=π±2πm) depending upon the operation mode of the 90°TLC cell and upon the initial polarization state. It is important to note that the above mentioned incidence plane may be defined as the plane containing the incident wave vector kᵢₙ and the normal of the surface 36 (FIG. 5) for the example of the rhomb of Fresnel. However, in the case when there is no tilted light incidence (as in many other achromatic optical elements), then this plane must be defined as the plane with specific (often called eigene) polarization properties, for example, such as slow or rapid optical axes.

This apparatus allows to obtain a set of four possible output polarization states, depending on the modes of the first two polarization changing elements, which are the only ones switchable. For example, imagine that the rotation directions of the illustrated cells are right handed and that we have a plane polarized (along the x axis) light, which is incident on the 90°TLC cell. For the simplest mode of no voltages on both cells (mode 00), we shall obtain first a 90° rotation (mode 0) and then a 45° rotation (mode 00) of the polarization plane of light before interring into the BBPD. In this case, light will generate both polarization components in the BBPD and the final polarization of the output light from the BBPD will be a −σ circular polarization. This transformation will be the same for many wavelengths since all the transformations used are broadband. The application of the voltage only on the 90°TLC cell (mode 1) will eliminate the first rotation and the polarization plane of the incident light will then, after the 45°TLC cell, make +45° with respect to the incidence plane of the BBPD (mode 10). In this case, the final polarization state of the output light from the BBPD will be circular with a circularity sign a, which is opposed to the one in the mode 00 (without fields). Thus, we obtain an electrically controllable achromatic (broadband) quarter wave device, which transforms the linear polarized light into circular one and which, in addition, can invert the output circular polarization sign without using any mechanically moving parts. In addition, this device can provide also two plane polarized states p and s, if respectively, electrical fields are applied on both LC cells (mode 11) and if a field is applied only on the 45°TLC cell (mode 01). We can thus obtain the following polarization states: p, s, σ, −σ (see the sphere of Poincare, FIG. 1).

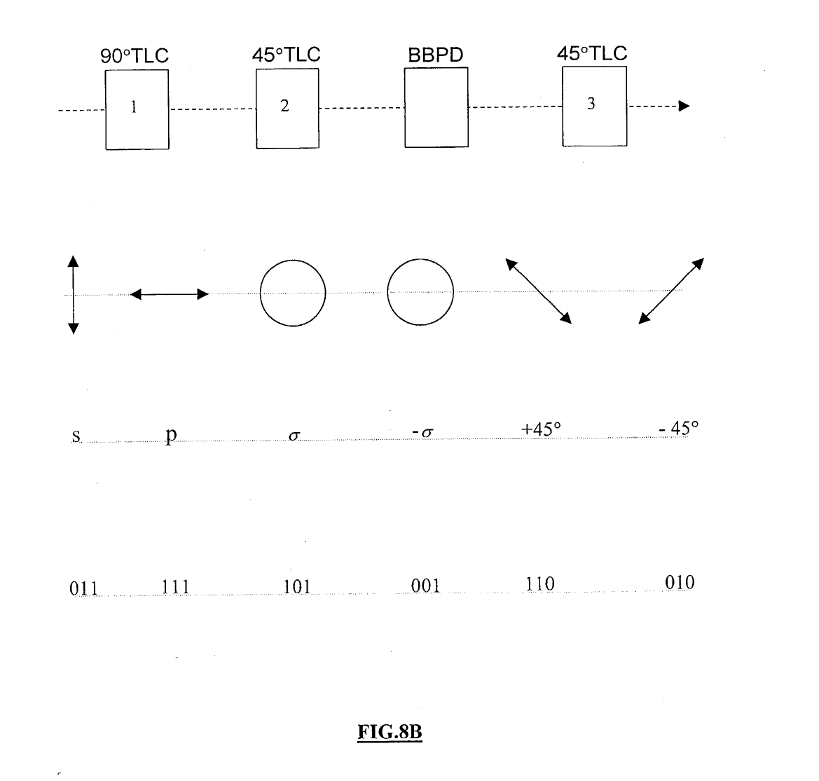

Referring to FIG. 8A, there is shown yet another apparatus according to a preferred embodiment of the invention having all the same components as the device of FIG. 7 with an additional 45°TLC cell 24′ disposed after the BBPD. Appropriate switching means are also provided to switch this 45°TLC cell 24′ between modes 0 and 1. As will be understood below, the complete set of 6 extreme polarization states may be obtained using this device.

The additional 45°TLC cell 24′ is oriented so that the output p or s polarization planes from the BBPD are pure polarization (eigen) modes for this 45°TLC cell in the mode 0. It means that they are either parallel or perpendicular to the orientation of the director n of this cell at its entrance. In this case (with again a right handed rotation of the last cell), we can obtain a +45° tilted plane polarized light with fields are applied only on two initial TLC cells 14 and 24 (mode 110), and a −45° tilted plane polarized light when a field is applied only on the first 45°TLC cell 24 (mode 010). It will be noted that the operation of the device of the FIG. 8 will be simply reduced to the operation of the device of the FIG. 7 if a switching voltage is applied to the last element 24′.

Referring to FIG. 8B, the operation modes of the device of FIG. 8A are described in detail. The upper line shows an example of the positioning of key elements of the system. The second line represents the 6 extreme polarization states that may be obtained in achromatic way (with reduced wavelength sensitivity). The third line shows the conditional notations we have used in the text and symbolic figures to describe these polarization states. The last line shows the codes that may be used to obtain the above-mentioned polarization states. Thus, for an incident, e.g., p plane polarized light (along x-axis) we can get at the output of the device:

a) the same p polarization, if switching electric fields are applied to all LC cells 14, 24 and 24′;

b) linear s polarization (rotated at 90° with respect to the incident one) if switching electric fields are applied only on the two last LC cells 24 and 24′;

c) circular (σ) polarization if switching electric fields are applied only on the first and last LC cells 14 and 24′;

d) circular (−σ) polarization if switching electric field is applied only on the last LC cell 24′;

e) linear +45° polarization (rotated at +45° with respect to the incident one) if switching electric fields are applied only on the two first LC cells 14 and 24; and

f) linear −45° polarization (rotated at −45° with respect to the incident one) if a switching electric field is applied only on the second LC cell 24.

A similar performance may be obtained also for an incident light with plane polarization along the y-axis. Note also that, all the intermediate (e.g., elliptical) polarization states also may be obtained using the above-described device during transitions between 6 extreme polarization states or using weaker fields compared to those required for the complete switching. This operation however will be wavelength sensitive and will probably require from the user a calibration of the device for each wavelength. In a possible version of application of the proposed device, electronic means may be provided to synchronize the polarization state generation and the detection of a desired parameter of, e.g., a multi-channel communication network, if the device is used, for example, in performance monitoring.

It will be appreciated that the operation of the device may be improved, for example, by changing the order of positioning of various components or using more LC cells, which will transform the polarization state of light in an achromatic way similar to the one described in the present invention. An example of such a modification may be the replacement of one of the described elements by a similar one, or just the removal of a component, if not all key polarization states are required. An example of an improvement of the device could be the use of two or more LC cells of less thickness to perform the same, but gradual achromatic polarization rotation, which was described above to be done with only one cell, but with much smaller response time, accelerating thus the switching time of the device.

The speed of the device may also be improved when using other than “traditional” LC materials. An example of such a material may be a nematic LC having dielectric anisotropy, which changes the sign when changing the frequency of the driving voltage. In this case the destabilization of the initial orientation may be done with a frequency corresponding to the positive dielectric anisotropy of the LC, and we can quickly bring back the system to the initial or intermediate twisted states with a frequency of driving signals corresponding to the negative dielectric anisotropy of the LC. Any other, non-electrical excitation mechanisms that can result in the switching of described devices may be used for the same purposes.

It is also understood that the operation of the device may be improved, for example, by using an input polarizer, polarization controlling device or a polarized light source. The choice of the input polarization may be affected also by the criteria of the desired extinction ratio, to limit the noise of the device, since the extra-ordinary mode of light polarization typically suffers more scattering in LC materials than the ordinary polarized light. Thus, the LC elements can be arranged to be preferably in ordinary mode for light propagation in the mode 0.

An improvement of the device may be the use of monolithic solutions to build the described above components with common substrates or blocks, index matching liquids, antireflection dielectric layers and other means to reduce the losses of the device on reflections. The same basic principles of operation may also be used to create guided wave broadband polarization switching devices.

Another improvement of the system may be the use of additional optical elements to reduce the angular or transversal deviations of the output beam, which may be a problem for pre-designed photonic systems.

A useful application of the device may be its use in performance monitoring devices to generate various key polarization states simultaneously for a light with broad spectrum (e.g., multiple communication channels).

Another application of the device may be its use in spectrometers or elipsometers to switch its operation from a given plane-polarized absorption-probing regime to a regime of measurements of linear or circular dichroism of material systems under test. A similar switch of a pump light, instead of probe, may be used also during active excitation schemes when the switch of pump beam's polarization may change the behavior of the material under excitation.

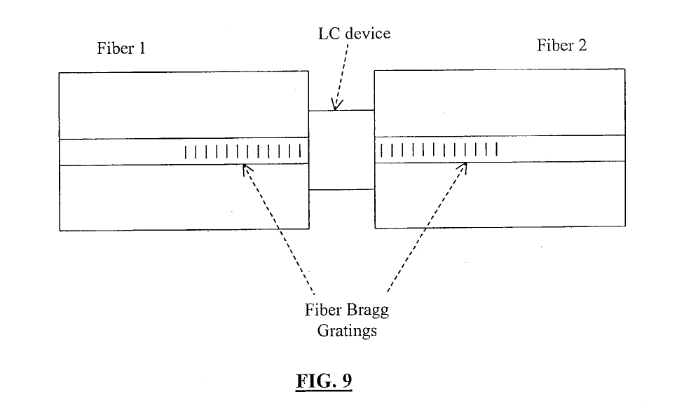

It is also possible to construct an all-fiber embodiment of the present invention, which would be particularly advantageous for optical telecommunications applications. For example, referring to FIG. 9, instead of standard “free-space” twisted liquid crystal cells with “bulk substrates”, the polarization changing element may be embodied by the cut (e.g., cleaved, polished, etc.) surfaces of two optical fibers, defining the input and output substrates of the LC element, and a drop of liquid crystal deposited between the two. The fibers used may be of standard type or, e.g., polarization maintaining ones. In the last case, the proper orientation of LC molecules (at the first and second fiber end-faces) with respect to the polarization specific axes of the fiber will allow the broadband switch and further guiding of the plane polarization state of light. The switching of the device may be achieved by means of transparent longitudinal (along the light propagation) or lateral electrodes.

In the case when, in contrast, specific spectral properties are required, then such an embodiment would be particularly adapted for use in combination with periodic fiber structures such as Bragg gratings or multiplayer reflective elements created before and after the LC device to spectrally design the output light beam. An example of realization of such a structure can be the fiber Bragg grating (FIG. 11) cleaved in the middle and filled by the LC material with appropriate orientational distribution of molecules, which would provide very narrowband spectral selectivity.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A broadband polarization transformation apparatus for switching a polarization state of a light beam from a linear initial polarization state to one of a plurality of output polarization states irrespectively of a spectral distribution of said light beam, the apparatus comprising:
a switchable first polarization changing element having an input plane and two perpendicular polarization specific axes lying therein, the light beam impinging normally on said input plane with its initial polarization state aligned with one of said polarization specific axes;
first switching means for switching the first polarization changing element between a first mode outputting the light beam with its polarization rotated into alignment with the other one of said polarization specific axes, and a second mode outputting the light beam with its polarization unchanged;
a switchable second polarization changing element having an input plane and two perpendicular polarization specific axes lying therein in alignment with the polarization specific axes of the first polarization changing element, the light beam outputted from the first polarization changing element impinging normally on said input plane; and
second switching means for switching the second polarization changing element between a first mode outputting the light beam with its polarization rotated by a predetermined angle, and a second mode outputting the light beam with its polarization unchanged.

2. An apparatus according to claim 1, wherein said first and second polarization changing elements each comprise at least one electro-optic device.

3. An apparatus according to claim 2, wherein each of said electro-optic devices comprises a twisted liquid crystal cell having an input surface and an output surface.

4. An apparatus according to claim 3, wherein said first and second switching means each comprise:
a pair of transparent electrodes respectively mounted on the input and output surfaces of the corresponding twisted liquid crystal cell for generating an electric field therebetween; and
at least one power source connected to said pairs of electrodes.

5. An apparatus according to claim 4, wherein said predetermined angle of rotation of the second polarization changing element is about 45 degrees.

6. An apparatus according to claim 5, further comprising a third polarization changing element positioned to receive therethrough the light beam outputted from the second polarization changing element, said third polarization changing element having two perpendicular polarization specific axes and introducing a phase delay between polarization components of the light beam respectively aligned with said polarization specific axes.

7. An apparatus according to claim 6, wherein said polarization specific axes of the third polarization changing element are aligned with the polarization specific axes of the first and second polarization changing element.

8. An apparatus according to claim 7, wherein said phase delay is an integer multiple of π/2.

9. An apparatus according to claim 8, wherein said third polarization changing element comprises a rhomb of Fresnel.

10. An apparatus according to claim 8, further comprising:
a switchable fourth polarization changing element positioned to receive therethrough the light beam outputted from the third polarization changing element, said fourth polarization changing element having two perpendicular polarization specific axes, aligned with the polarization specific axes of the first, second and third polarization changing elements; and
third switching means for switching the fourth polarization changing element between a first mode outputting the light beam with its polarization rotated by a predetermined angle, and a second mode outputting the light beam with its polarization unchanged.

11. An apparatus according to claim 10, wherein said fourth polarization changing element comprises at least one electro-optic device.

12. An apparatus according to claim 11, wherein said electro-optic device comprises a twisted liquid crystal cell having an input surface and an output surface.

13. An apparatus according to claim 12, wherein said third switching means comprise:
a pair of transparent electrodes respectively mounted on the input and output surfaces of the corresponding twisted liquid crystal cell for generating an electric field therebetween; and
at least one power source connected to said pair of electrodes.

14. An apparatus according to claim 13, wherein said predetermined angle of rotation of the fourth polarization changing element is about 45 degrees.

15. A broadband polarization transformation apparatus for switching a polarization state of a light beam from a linear initial polarization state to one of a plurality of output polarization states irrespectively of a spectral distribution of said light beam, the apparatus comprising:
a switchable first polarization changing element positioned to receive the light beam therethrough, said first polarization changing element having two perpendicular polarization specific axes, one of said polarization specific axes being aligned with the initial polarization state of said light beam;
switching means for switching the first polarization element between a first mode outputting the light beam with its polarization rotated by a predetermined angle, and a second mode outputting the light beam with its polarization unchanged; and
a second polarization changing element positioned to receive therethrough the light beam outputted from the first polarization changing element, said second polarization changing element having two perpendicular polarization specific axes and introducing a phase delay between polarization components of the light beam respectively aligned with said polarization specific axes.

16. An apparatus according to claim 15, wherein said first polarization changing element comprises at least one electro-optic device.

17. An apparatus according to claim 16, wherein said electro-optic device comprises a twisted liquid crystal cell having a input surface and an output surface.

18. An apparatus according to claim 17, wherein said switching means comprise:
a pair of transparent electrodes respectively mounted on the input and output surfaces of the twisted liquid crystal cell for generating an electric field therebetween; and
at least one power source connected to said pair of electrodes.

19. An apparatus according to claim 18, wherein:
said predetermined angle is about 45 degrees; and
one of the polarization specific axes of the second polarization changing element is aligned with the polarization of the light beam outputted from the first polarization changing element in one of said first and second modes.

20. An apparatus according to claim 18, wherein:
said predetermined angle is about 90 degrees; and
the polarization specific axes of the second polarization changing element being aligned make an angle of about 45° with the polarization specific axes of the first polarization changing element.

21. An apparatus according to claim 18, wherein said phase delay is a multiple of π/2.

22. An apparatus according to claim 21, wherein said polarization changing element comprises a rhomb of Fresnel.
